(19) United States
(12) Patent Application Publication
(10) Pub. No.: US 2025/0263975 A1
(43) Pub. Date: Aug. 21, 2025

(54) SOLAR ENERGY COLLECTING BLIND ARRANGEMENT

(71) Applicant: Susan Al Tekreeti, Lombard, IL (US)

(72) Inventor: Susan Al Tekreeti, Lombard, IL (US)

(21) Appl. No.: 18/583,325

(22) Filed: Feb. 21, 2024

(51) Int. Cl. E06B 9/386; E06B 9/24; E06B 9/32; F24S 20/61; F24S 25/00; F24S 30/20

(52) U.S. Cl. CPC E06B 9/386; E06B 9/32; F24S 20/61; F24S 30/20; E06B 2009/2488; F24S 2025/804

(57) ABSTRACT

A solar energy collecting blind arrangement includes a blind housing, blind slats, and a retraction arrangement. Each of the blind slats includes a top layer and bottom layer. The top layer is designed to be positioned to face substantially toward a window and the bottom layer is designed to be positioned to face substantially toward an interior space. The top layer includes a solar-collecting material designed to absorb solar energy. The bottom layer includes a heat-emitting material designed to transfer heat energy into passing air in an interior space to thereby heat the interior space.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to blind arrangements and more particularly pertains to a new solar energy collecting blind arrangement. Blinds are used to cover windows to both prevent persons from seeing in and to prevent light and heat from coming into the room from the sun. However, it could be advantageous to utilize a blind arrangement for other reasons, such as collecting solar energy for heating purposes.

### (2) Description of Related Art Including Information Disclosed Under 37 CFR 1.97 and 1.98

The prior art relates to blind arrangements. The prior art, as best understood, does not disclose a blind arrangement with a top layer for absorbing solar energy and a bottom layer for transferring the heat energy to the air in a room.

### BRIEF SUMMARY OF THE INVENTION

An embodiment of the disclosure meets the needs presented above in a solar energy collecting blind arrangement that includes a blind housing, blind slats, and a retraction arrangement. The blind housing is designed to be mounted on a wall adjacent a window. The blind slats suspended from the blind housing by cords. The retraction arrangement is operatively connected to the blind slats to permit a user to retract the blind slats upwardly toward the blind housing to partially or fully expose a window, as well as extend the blind slats downwardly away from the blind housing to partially or fully cover a window. Each of the blind slats includes a top layer and bottom layer. The top layer is designed to be positioned to face substantially toward a window and the bottom layer is designed to be positioned to face substantially toward an interior space. The top layer includes a solar-collecting material designed to absorb solar energy. The bottom layer includes a heat-emitting material designed to transfer heat energy into passing air in an interior space to thereby heat the interior space.

The blind arrangement is designed to take advantage of solar energy to help heat a room and reduce heating costs. For example, if the sun heats the top layer of the blind slat to about 95 degrees Fahrenheit, heat energy can be conducted to the bottom layer. As air passes over the bottom layer, which air is cooler than 95 degrees, such as 67 degrees, the circulating air will pick up some of the heat in the manner of a heat exchanger or heating unit. As a result, the room air could be increased in temperature by 10-15 degrees, thereby heating the room and saving on energy costs.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a solar energy collecting blind arrangement according to an embodiment of the disclosure.

FIG. 2 is a side view of an embodiment of the disclosure.

FIG. 3 is a front view of an embodiment of the disclosure.

FIG. 4 is a cross-sectional view of an embodiment of the disclosure.

FIG. 5 is a side view of an embodiment of the disclosure in use.

### DETAILED DESCRIPTION OF THE INVENTION

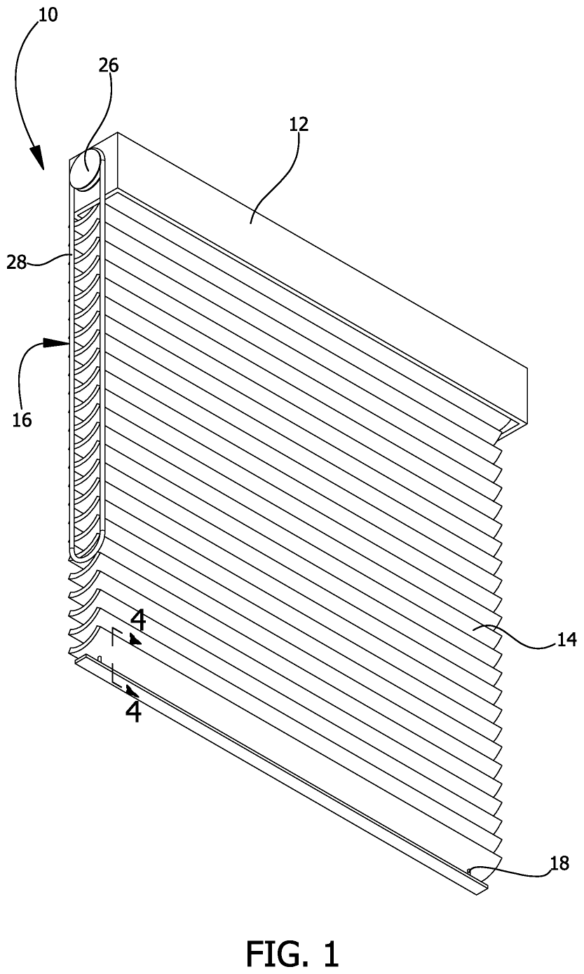

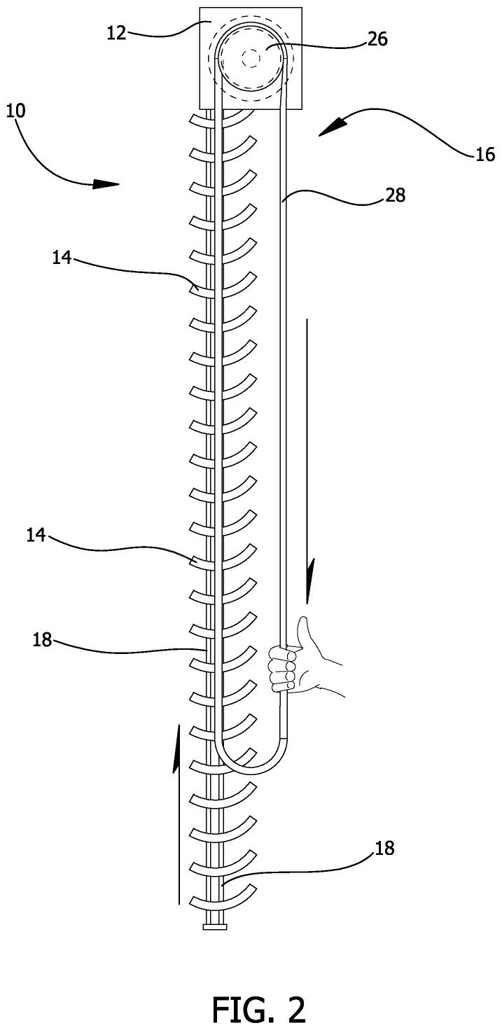

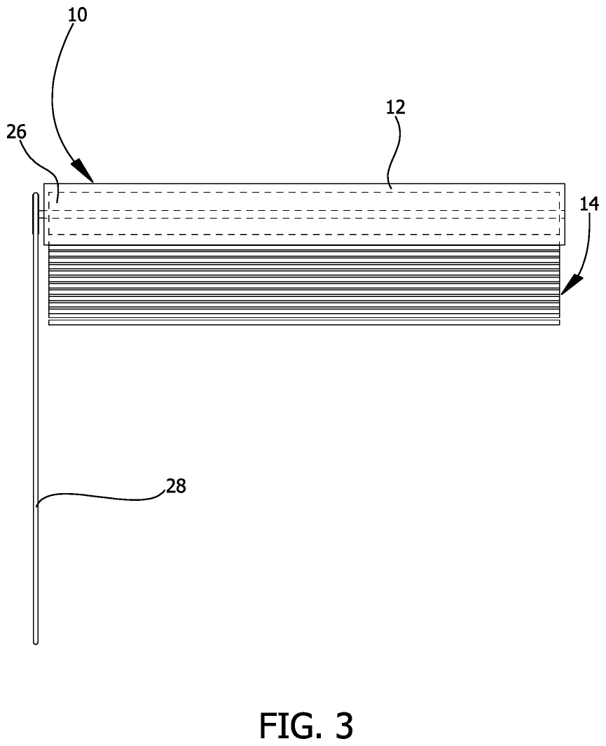

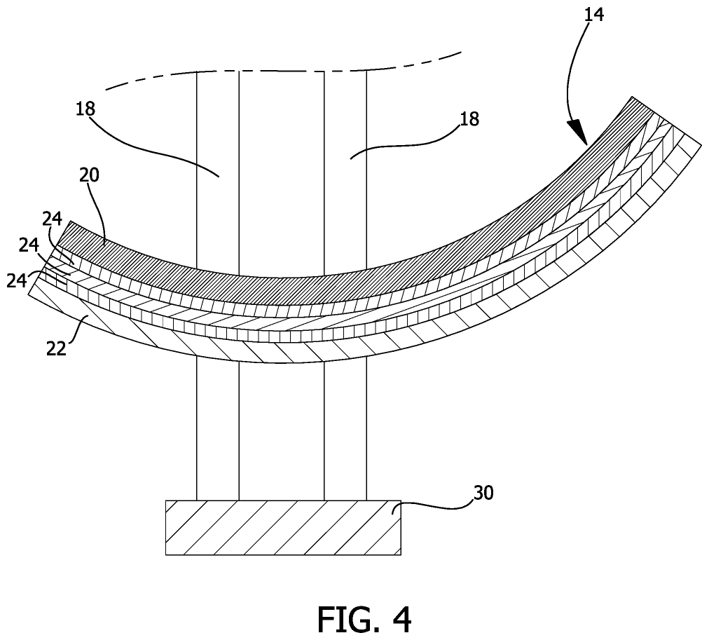

With reference now to the drawings, and in particular to FIGS. 1 through 5 thereof, a new solar energy collecting blind arrangement embodying the principles and concepts of an embodiment of the disclosure and generally designated by the reference numeral 10 will be described.

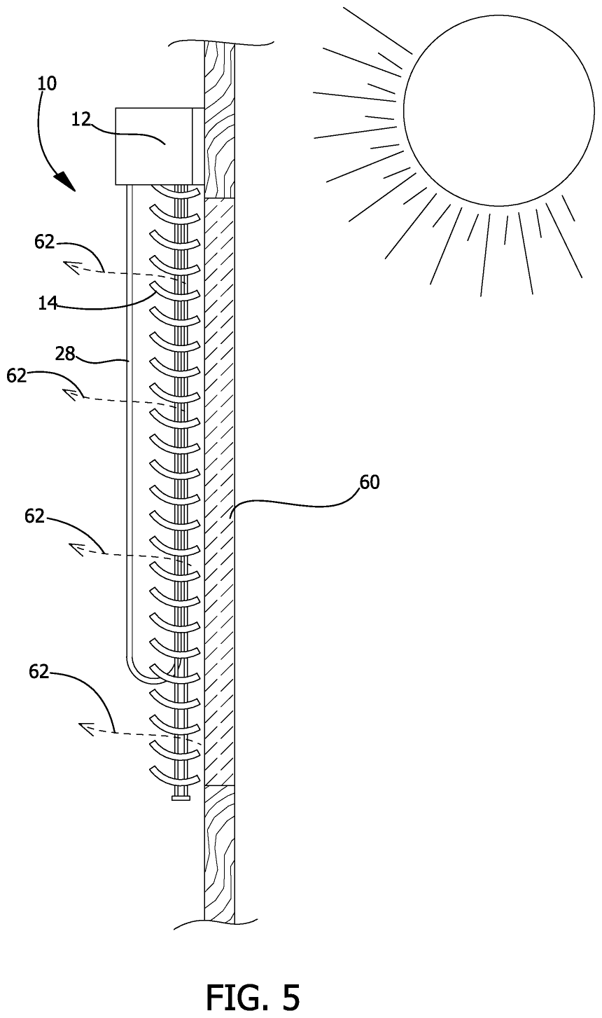

As best illustrated in FIGS. 1 through 5, the solar energy collecting blind arrangement 10 generally comprises A solar energy collecting blind arrangement 10 that includes a blind housing 12, blind slats 14, and a retraction arrangement 16. The blind housing 12 is designed to be mounted on a wall adjacent a window 60. The blind slats 14 are suspended from the blind housing 12 by cords 18. The retraction arrangement 16 is operatively connected to the blind slats 14 to permit a user to retract the blind slats 14 upwardly toward the blind housing 12 to partially or fully expose a window 60, as well as extend the blind slats 14 downwardly away from the blind housing 12 to partially or fully cover a window 60. Each of the blind slats 14 includes a top layer 20 and bottom layer 22. The top layer 20 is designed to be positioned to face substantially toward a window 60 and the bottom layer 22 is designed to be positioned to face substantially toward an interior space, such as a room of a house or an office. The top layer 20 includes a solar-collecting material designed to absorb solar energy. The bottom layer 22 includes a heat-emitting material designed to transfer heat energy into passing air 62 in an interior space to thereby heat the interior space. As seen in FIG. 5, the sun heats the top layer 20 and then cooler room air 62 passes over the blind slats 14 and is heated to a higher temperature to thereby heat the room or supplement the heating of the room.

In accordance with at least one possible embodiment, each of the blind slats 14 includes at least one middle layer 24 positioned between the top layer 20 and the bottom layer 22. The one or more middle layers 24 includes a thermally-conductive material designed to conduct heat energy from the top layer 20 to the bottom layer 22.

In accordance with at least one possible embodiment, each of the blind slats 14 is curved such that the top layer 20 presents a concave profile to aim more of the top layer 20 toward the sun to collect more solar energy and the bottom layer 22 presents a convex profile to increase the surface area in contact with passing air in an interior space.

In accordance with at least one possible embodiment, the top layer 20 is colored black or other dark color to maximize absorption of solar energy. The bottom layer 22 is colored white or other light color.

In accordance with at least one possible embodiment, the blind slats 14 have a surface area of about 8 to 12 square feet and are designed to elevate room temperature by about 10-15 degrees Fahrenheit.

In accordance with at least one possible embodiment, the blind slats 14 are spaced apart from one another to permit air flow therebetween.

In accordance with at least one possible embodiment, the retraction arrangement 16 includes a spool shaft 26 designed to roll up the cords 18 connecting the blind slats 14. The retraction arrangement 16 includes a cord loop 28 operatively connected to the spool shaft 26 to permit a user to rotate the spool shaft 26 to retract and extend the blind slats 14. The retraction arrangement 16 could also include a base 30 that helps gather up the blind slats 14. It should be understood that any conventional blind design could be designed to incorporate the blind slats 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A solar energy collecting blind arrangement comprising:
a blind housing configured to be mounted on a wall adjacent a window;
blind slats suspended from said blind housing by cords;
a retraction arrangement being operatively connected to said blind slats to permit a user to retract said blind slats upwardly toward said blind housing to partially or fully expose a window and extend said blind slats downwardly away from said blind housing to partially or fully cover a window;
each of said blind slats comprising a top layer and a bottom layer;
said top layer being configured to be disposed to face substantially toward a window and said bottom layer being configured to be disposed to face substantially toward an interior space;
said top layer comprising a solar-collecting material configured to absorb solar energy; and
said bottom layer comprising a heat-emitting material configured to transfer heat energy into passing air in an interior space to thereby heat the interior space.

2. The solar energy collecting blind arrangement of claim 1, wherein:
each of said blind slats comprises at least one middle layer disposed between said top layer and said bottom layer; and
said at least one middle layer comprises a thermally-conductive material configured to conduct heat energy from said top layer to said bottom layer.

3. The solar energy collecting blind arrangement of claim 2, wherein each of said blind slats is curved such that said top layer presents a concave profile to aim more of said top layer toward the sun to collect more solar energy and said bottom layer presents a convex profile to increase the surface area in contact with passing air in an interior space.

4. The solar energy collecting blind arrangement of claim 3, wherein:
said top layer is colored black or other dark color to maximize absorption of solar energy; and
said bottom layer is colored white or other light color.

5. The solar energy collecting blind arrangement of claim 4, wherein said blind slats have a surface area of about 8 to 12 square feet and are configured to elevate room temperature by about 10-15 degrees Fahrenheit.

6. The solar energy collecting blind arrangement of claim 5, wherein said blind slats are spaced apart from one another to permit air flow therebetween.

7. The solar energy collecting blind arrangement of claim 6, wherein:
said retraction arrangement comprises a spool shaft configured to roll up said cords connecting said blind slats; and
said retraction arrangement comprises a cord loop operatively connected to said spool shaft to permit a user to rotate said spool shaft to retract and extend said blind slats.

8. The solar energy collecting blind arrangement of claim 1, wherein each of said blind slats is curved such that said top layer presents a concave profile to aim more of said top layer toward the sun to collect more solar energy and said bottom layer presents a convex profile to increase the surface area in contact with passing air in an interior space.

9. The solar energy collecting blind arrangement of claim 1, wherein:
said top layer is colored black or other dark color to maximize absorption of solar energy; and
said bottom layer is colored white or other light color.

10. The solar energy collecting blind arrangement of claim 1, wherein said blind slats have a surface area of about 8 to 12 square feet and are configured to elevate room temperature by about 10-15 degrees Fahrenheit.

11. The solar energy collecting blind arrangement of claim 1, wherein said blind slats are spaced apart from one another to permit air flow therebetween.

12. The solar energy collecting blind arrangement of claim 1, wherein:
said retraction arrangement comprises a spool shaft configured to roll up said cords connecting said blind slats; and
said retraction arrangement comprises a cord loop operatively connected to said spool shaft to permit a user to rotate said spool shaft to retract and extend said blind slats.
